(19) United States
(12) Patent Application Publication
(10) Pub. No.: US 2026/0090689 A1
(43) Pub. Date: Apr. 2, 2026

(54) METHOD OF DETERMINING AN AIRFLOW RATE THROUGH A MOTOR ASSEMBLY OF AN AIR-MOVING DEVICE

(71) Applicant: Dyson Technology Limited, Malmesbury, Wiltshire (GB)

(72) Inventors: Mehdi SALEHIFAR, Chippenham (GB); Andrew John ISAACS, Tetbury (GB)

(21) Appl. No.: 19/110,499

(22) PCT Filed: Sep. 11, 2023
(86) PCT No.: PCT/IB2023/058992

§ 371 Date: Mar. 11, 2025

(30) Foreign Application Priority Data
Sep. 13, 2022 (GB) 2213326.8

(51) Int. Cl. A47L 9/28; G01F 1/36; G01F 1/50

(52) U.S. Cl. CPC A47L 9/2821; G01F 1/363; G01F 1/50

(57) ABSTRACT

A method of determining a value of an airflow rate through a motor assembly of an air-moving device. The method includes measuring a first value of a first pressure at a first position in the motor assembly during operation. The method also include measuring, a second value of a second pressure at a second position in the motor assembly during operation of the motor of the motor assembly, where the second position is downstream of the first position. The method also includes performing a determination process based on the first value and the second value to determine the value of the airflow rate through the motor assembly.

### FIELD OF THE INVENTION

The present invention relates to method of determining an airflow rate through a motor assembly of an air-moving device, a set of machine-readable instructions for causing the method to be performed, and an air-moving device having a storage comprising such instructions and a processor configured to perform the method by executing the instructions.

### BACKGROUND OF THE INVENTION

There is a general desire to improve air-moving devices, such as vacuum cleaners, in a number of ways. For example, improvements may be desired in terms of efficiency, manufacturing cost, flexibility of use and reliability.

### SUMMARY OF THE INVENTION

According to a first aspect of the invention, there is provided a method of determining a value of an airflow rate through a motor assembly of an air-moving device, the method comprising: measuring, during operation of a motor of the motor assembly, a first value of a first pressure at a first position in the motor assembly; measuring, during operation of the motor of the motor assembly, a second value of a second pressure at a second position in the motor assembly, the second position being downstream of the first position; and performing a determination process to determine, based on the first value and the second value, the value of the airflow rate through the motor assembly.

The method provides an accurate and reliable method to measure airflow rate in the air-moving device. The method may be easy to calibrate for the air-moving device and may be applicable regardless of the architecture of the motor assembly of the device. The method may also provide a computationally efficient way of determining the airflow rate, since the first value and the second value may be mapped accurately and robustly to airflow rate values.

The determination process may comprise determining a first dynamic pressure value of the motor based on the first value and the second value, and wherein the determining of the airflow rate through the motor assembly is based on the first dynamic pressure value.

The first value and the second value may readily allow a dynamic pressure measurement to be obtained which can be mapped effectively to a value of an airflow rate.

The method may comprise determining an ambient pressure value, and wherein the determining the airflow rate comprises compensating for the determined ambient pressure value. The method may also comprise compensating for a determined ambient temperature value.

Determining and compensating for the ambient pressure and/or temperature value may provide for determining a reliable and accurate value of the airflow rate in a range of different ambient conditions.

The method may comprise measuring the ambient pressure value at the first position when the motor is not in operation. The method may also comprise measuring an ambient temperature value. The ambient temperature value may also be measured at the first position.

Measuring the ambient pressure and/or temperature at the first position allows for a reliable and accurate value of the ambient pressure and/or temperature at the first position to be obtained which can be used to compensate the first value for ambient conditions.

The first position may be located in a first part of the motor assembly having a first cross-sectional area and the second position may be located in a second part of the motor assembly having a second cross-sectional area different to the first cross-sectional area.

The first position and the second position being located at respective first and second parts of the motor assembly having different cross-sectional areas may provide for there to be a reliably measurable difference in pressure between the first position and the second position when the motor is in operation. This may allow for the calculation of the value of the airflow rate based on the first value and the second value to be robust and accurate.

The first cross-sectional area may be greater than the second cross-sectional area.

The first cross-sectional area being greater than the second cross-sectional area may provide for a geometry corresponding to a bell mouth, which is such that a given difference in the first value and the second value accurately indicates a given airflow rate.

The first position may be upstream of a coil assembly of the motor and the second position may be downstream of the coil assembly of the motor and upstream of an impeller of the motor.

These may be convenient respective locations for the first value and the second value to be measured such that the first and second values can be used to reliably infer airflow rate.

The measuring the second value of the second pressure at the second position may comprise measuring the second value at a third position fluidly connected to the second position by a first fluid connection, or the measuring the first value of the first pressure at the first position may comprise measuring the first value at a fourth position fluidly connected to the first position by a second fluid connection.

This may allow for the first value or the second value to be measured at convenient locations in the motor assembly which allow the airflow rate to be accurately inferred while positioning pressure sensors at locations in the motor assembly other that the first position or the second position. This may be convenient where, for example, it may be impractical to position a sensor at one or other of the first position and the second position.

The first fluid connection and/or the second fluid connection may be provided by one or more respective ducts.

This may provide a convenient method of measuring pressure at the first position and/or the second position by sensors located at positions other than, respectively, the first position and the second position.

At least one of the one or more respective ducts may be integral with a housing of the motor assembly.

A duct being integral with the housing of the motor assembly may be a convenient way of providing a duct in a space-efficient manner and may also involve minimal additional manufacturing expense.

The first value and the second value may be measured by respective first and second pressure sensors located at upstream positions in the motor assembly, and the second pressure sensor may be configured to measure the second value at the third position fluidly connected by the first fluid connection to the second position.

This may allow the first and second pressure sensors both to be located in a convenient location upstream of the motor, for example on a PCB of the air-moving device.

The first value and the second value are measured by respective first and second pressure sensors, wherein the first pressure sensor is at an upstream position in the motor assembly and the second pressure sensor is at a downstream position in the motor assembly.

This may provide for the second value to be measured without providing a fluid connection to allow the second value to be measured. For example, the second pressure sensor may be located at an inlet to or an outlet from an impeller of the motor.

The method may comprise using the determined airflow rate to determine: a filter loading condition of the air-moving device; a blockage condition of the air-moving device; or a dynamic loading condition of the air-moving device.

This may allow for an airflow rate provided by the method to be used to reliably and accurately determine other parameters which can be inferred based on flow rate, such as a filter loading condition, a blockage condition or a dynamic loading condition of the air-moving device.

According to a second aspect of the invention, there is provided a set of machine-readable instructions which when executed by a processor of an air-moving device cause the air-moving device to perform a method according to the first aspect of the invention.

According to a first aspect of the invention, there is provided an air-moving device comprising: a processor; and a storage comprising a set of machine-readable instructions which when executed by the processor cause the processor to perform a method according to the first aspect of the invention.

The air-moving device may comprise: a first pressure sensor configured to measure the first value of the first pressure at the first position in the motor assembly; and a second pressure sensor configured to measure the first value of the first pressure at the first position in the motor assembly.

The air-moving device may be a vacuum cleaner.

Optional features of aspects of the present invention may be equally applied to other aspects of the present invention, where appropriate.

### BRIEF DESCRIPTION OF THE DRAWINGS

The present invention will now be described, by way of example only, with reference to the following figures, in which:

FIG. 1 shows a schematic representation of an example motor assembly of an air-moving device;

FIG. 2 shows an example of an air-moving device;

FIG. 3 is a flow chart representation of a method of determining a value of an airflow rate through a motor assembly of an air-moving device;

FIG. 4 shows aspects of an example method of determining an airflow rate through a motor assembly of an air-moving device;

FIG. 5 shows a schematic representation of another example motor assembly of an air-moving device;

FIG. 6 shows a schematic representation of certain components of a motor assembly of an air-moving device according to an example; and

FIG. 7 shows a schematic representation of certain components of an example motor assembly of an air-moving device according to another example.

### DETAILED DESCRIPTION OF THE INVENTION

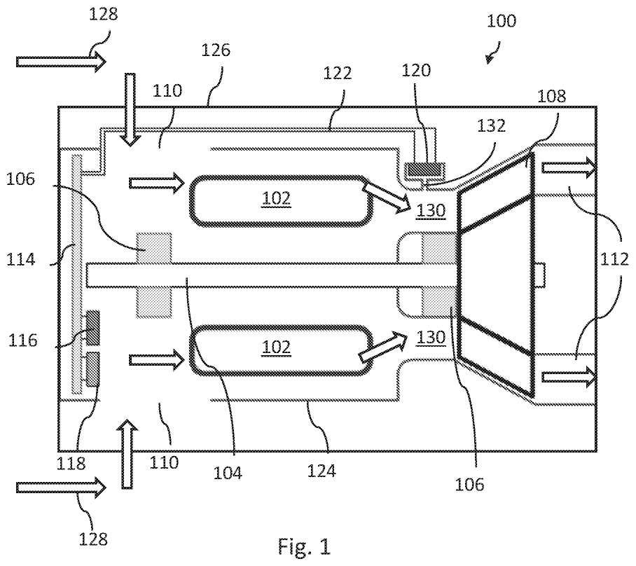

FIG. 1 shows an example schematic representation of a motor assembly 100 of an air-moving device. The motor assembly 100 comprises set of coils 102, a shaft 104 with magnets (not shown) mounted thereon, bearings 106, and an impeller 108. The motor assembly 100 comprises motor air inlets 110, and air outlets/diffuser 112. The motor assembly comprises a circuit board 114 on which are mounted sensor an ambient temperature sensor 116 and a first pressure sensor 118. The motor assembly 100 comprises a housing 124 in which the other components are housed. The motor assembly 100 further comprises a pre-motor filter 126 for filtering air which is drawn into the motor in use.

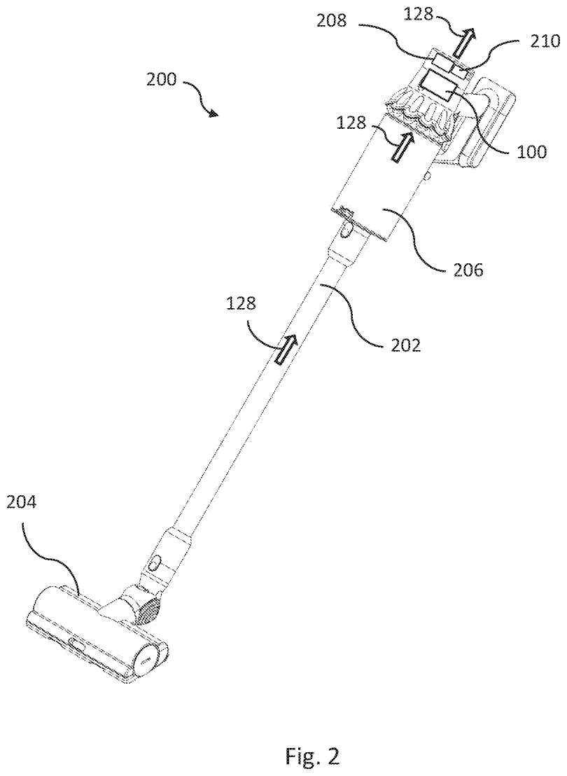

FIG. 2 shows an example air-moving device 200 comprising the motor assembly 100. The air-moving device 200 is a vacuum cleaner. The vacuum cleaner 200 comprises an inlet tube 202 with a tool 204 attached to a distal end of the inlet tube 202. The tool 204 is for engaging with a surface to be cleaned by the vacuum cleaner and comprises an air inlet (not shown) to the vacuum cleaner 200. The tool 204 may be active, comprising one or more mechanically-operated components, e.g. a rotating brush bar, to assist with cleaning tasks. In examples, the inlet tube 202 or a portion thereof may be removable. A tool, such as a passive tool, may be attached to the device 200 when the inlet tube 202 or the portion thereof is removed. Alternatively, the tool 204 may be passive and not comprise any such mechanically-operated components. A passive tool may nevertheless comprise elements such as bristles or the like to assist with cleaning tasks. The vacuum cleaner 200 also comprises a dirt-separating chamber 206, which may, for example, be a cyclone chamber. The vacuum cleaner 200 further comprises a processor 208 and a storage 210 for storing machine-readable instructions for execution by the processor 208 to control operation of components of the vacuum cleaner 200 including the motor 100. The machine-readable instructions when executed may cause the processor 208 to carry out any example method described herein.

In use, the motor of the motor assembly 100 draws air through the air inlet to the air-moving device 200, through the air-moving device 200, and out of an exhaust. Air is drawn through the device 200 along an airflow path 128 which passes through the inlet tube 202, through the dirt-separating chamber 206, through the motor assembly 100 and exits the device 200 through an exhaust.

Returning to FIG. 1, when the motor is in use in the air-moving device 200, an electric current is passed through the coils 102, in a manner which causes the generation of a varying magnetic field. This varying magnetic field is configured to act on the magnets on the shaft 104 to cause the shaft 104 to rotate about its longitudinal axis. This in turn rotates the impeller 108. Air, driven by the impeller 108, is drawn into the air-moving device 200 and along the airflow path 128. The airflow path 128 enters the motor assembly 100, passing through the pre-motor filter 126, which removes particulate matter from the air, and into the housing 124 through the air inlets 110. The airflow path 128 continues through the motor to the impeller 108 and, after passing over the impeller 108, exits the motor assembly 100 through the air outlets 112.

The motor assembly 100 further comprises a second pressure sensor 120 and wiring 122 which electrically connects the second pressure sensor 120 to circuit board 114. The motor assembly 100 further comprises an inlet tube 132 providing a fluid connection, through housing 124, from the second pressure sensor 120 to an inlet 130 of impeller 108. This allows the second pressure sensor 120 to take measurements of a pressure at the impeller inlet 130. As can be seen by the schematic representation of FIG. 1, a cross-sectional area of the motor is narrower at the impeller inlet 130 than at the motor inlet 110.

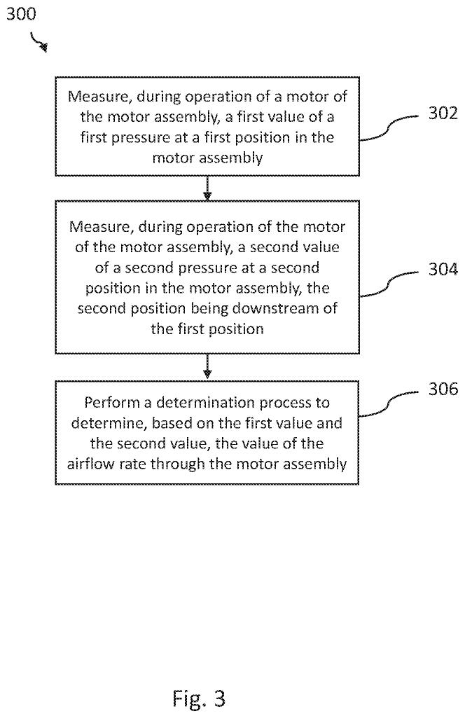

FIG. 3 shows a flow chart representation of an example method 300 of determining a value of an airflow rate through a motor assembly of an air-moving device.

The method 300 comprises, at block 302, measuring, during operation of a motor of the motor assembly, a first value of a first pressure at a first position in the motor assembly. The first value may be a value measured by a first pressure sensor at an upstream position in the motor assembly. For example, in the example motor assembly 100 of FIG. 1, the first value may be measured by the first pressure sensor 118.

The method 300 comprises, at block 304, measuring, during operation of the motor of the motor assembly, a second value of a second pressure at a second position in the motor assembly, the second position being downstream of the first position. The second position at which the second pressure is measured may be at a location in the air-moving device having a second cross-sectional area which is less than a first cross-sectional area of a location in the air-moving device at which the first pressure is measured. This may allow for a reliable different in pressure values to be measured between the first position and the second position. In some examples, a relationship between the first cross-sectional area and the second cross-sectional area may allow a different between the first pressure and the second pressure to be related in a pre-defined manner to an airflow rate. The second value may be a value measured by a second pressure sensor. For example, in the motor assembly 100 of FIG. 1, the second value may be measured by the second pressure sensor 120. In some examples, the second value may be measured by a second pressure sensor which is not located at the second position, as will be described in more detail below.

The method 300 comprises, at block 306, performing a determination process to determine, based on the first value and the second value, the value of the airflow rate through the motor assembly. The determination process may comprise determining a first dynamic pressure value of the motor based on the first value and the second value. The determining of the airflow rate may be based on the first dynamic pressure value. For example, the first dynamic pressure value may be related, by a pre-determined relationship, to an airflow rate through the motor assembly. The pre-determined relationship may, for example, be determined by a calibration process in which a dynamic pressure value determined based on values of the first pressure and the second pressure is measured simultaneously with an airflow rate through the motor, which may be measured with a suitable measurement apparatus. In some examples, the calibration process may comprise normalising the measurements of airflow rate and dynamic pressure based on other operating parameters of the device, such as the input power being supplied to the motor.

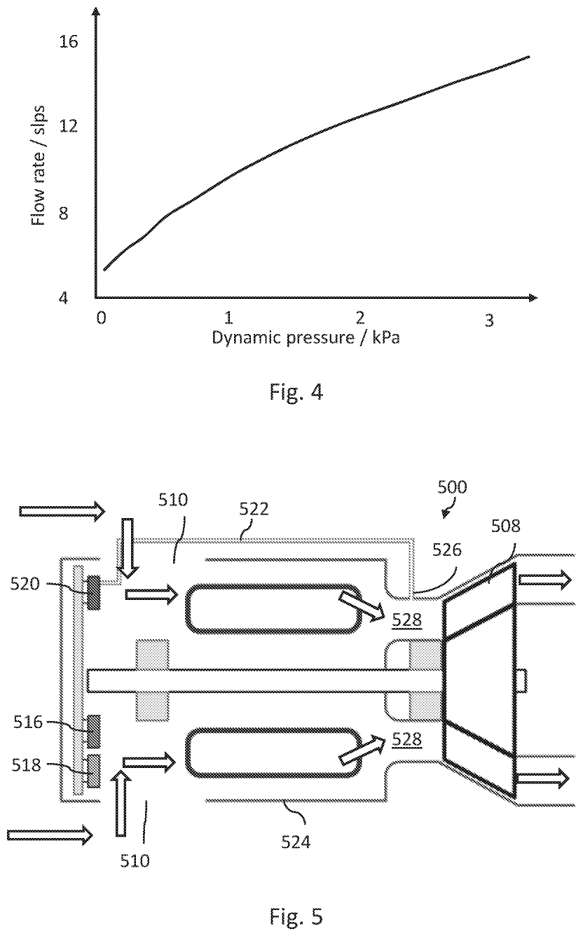

In one example, the determination process comprises: determining a value of a gauge static pressure in the motor assembly based on the first value of the first pressure at the first position and an ambient pressure value; determining a gauge total pressure at the impeller inlet based on the first value and the second value of the second pressure at the second position; determining a dynamic pressure based on the gauge static pressure and the gauge total pressure; determining a value of a dynamic pressure at standard temperature and pressure (STP) based on the dynamic pressure, the first value and an ambient temperature value; and determining the airflow rate through the motor assembly based on the dynamic pressure at STP. An example of this is described in more detail below. FIG. 4 shows an example schematic relationship between values of airflow rate and values of a first dynamic pressure, determined as described above based on values of the first pressure and the second pressure at respective first and second positions in an air-moving device. Airflow rate is shown on the y-axis in units of standard litres per second (slps) and the first dynamic pressure is shown on the x-axis in units of kPa. The first dynamic pressure may be a dynamic pressure at standard temperature and pressure (STP). As described above, the second position may be at an air inlet to an impeller of the device.

In examples, as described above, the first pressure and the second pressure at measured at parts of motor assembly having different cross-sectional areas. The airflow path through the device may accordingly be such that the air velocity differs between the first position at which the first pressure is measured and the second position at which the second pressure is measured. This air velocity difference may result in different absolute pressure measurements being recorded at the first position and the second position, which lie at different points along the airflow path. This may allow the geometry of the motor assembly along the airflow path to resemble a bell mouth and allow the airflow rate to be reliably and conveniently determined based on values of the first pressure and the second pressure.

When the device is in use, it may be impractical and/or costly to use such a measurement apparatus to measure the airflow rate. However, by performing such a calibration process, a reliable and accurate measure of the airflow rate through the device may be determined based on suitable pressure measurements. Having a reliable and accurate measure of a value of the airflow rate through the device in use may allow this value to be used for various purposes. For example, certain control aspects of the device may be based on a value of airflow rate. For instance, a relationship between a determined speed of the motor and the airflow rate may be used as a fault or blockage indicator. For example, if the speed of the motor is high while the airflow rate is low, this may indicate that there is a blockage to airflow through the device. This may be due to dirt clogging the filter and or object blocking an inlet tube of the device, for example. In one example, the airflow rate may be used to determine a value of a filter loading of the device. The filter loading may be a level of loading of a filter which filters particulate matter from the airflow which passes through the motor. For example, in the motor assembly 100 of FIG. 1, the filter loading may be a level of loading of the pre-filter 126. The level of loading of the filter may define how much dirt has been collected by the filter. In examples, this may be expressed in terms of the amount of dirt the filter may collect before it is deemed in need of replacing or cleaning. For example, a filter loading of 100% may represent that the filter has collected an amount of dirt such that it is deemed in need of replacing or cleaning. A filter loading level of 0% may represent that the filter has collected no dirt, e.g. because it has been fully cleaned or newly replaced. Typically, the level of filter loading may increase gradually during use of the device 200. As the filter gathers more dirt, it may provide a greater dynamic resistance to airflow into the motor. In some examples, the airflow rate may be used, for example in conjunction with a determined speed at which the motor is rotating, to estimate the level of filter loading.

By determining the value of the airflow rate in an accurate and reliable manner, control of the device may be made more reliable. For example, the occurrence of incorrect fault notifications may be reduced. Further, an accurate method for determining the airflow rate may allow for the motor power to be increased. For example, the maximum motor power may be limited in part by the minimum airflow rate that is measured. A more accurate determination of the airflow rate may allow the motor input power to be increased because the tolerance and uncertainty around the lowest airflow rate through the motor is reduced.

FIG. 5 shows another example schematic representation of a motor assembly 500. The motor assembly 500 comprises features corresponding to those of the motor assembly 100 described above with reference to FIG. 1, which, where labelled, are labelled with like reference numbers. The pre-motor filter is not shown in FIG. 5, for the sake of clarity.

The motor assembly 500 is the same as the motor assembly 100 of FIG. 1 with the exception that, in the motor assembly 500 of FIG. 5, the second pressure sensor 520 is located on the circuit board 514. A channel or duct 522 provides a fluid connection between the second pressure sensor 520 and the impeller inlet 530. The channel 522 allows the second pressure sensor 520 to take measurements of a pressure at the impeller inlet 530 without the second pressure sensor being located at the impeller inlet 530.

Such a channel may be provided by various means. In one example, the channel 526 may be formed by a pipe. The pipe may, for example, extend along an exterior surface of the housing 524 and extend through a hole 526 in the housing to provide the fluid connection from the second pressure sensor 520 to the impeller inlet 530. At an end of the channel 526 at which the second pressure sensor 520 is located, an air-tight seal may be formed around the second pressure sensor 520. The seal may, for example, comprise a circular, e.g. EPDM, foam seal sealing the pipe to a location on the circuit board 514 at which the second pressure sensor 120 is located. A similar seal may be formed around the second pressure sensor 120 of the motor assembly 100 of FIG. 1.

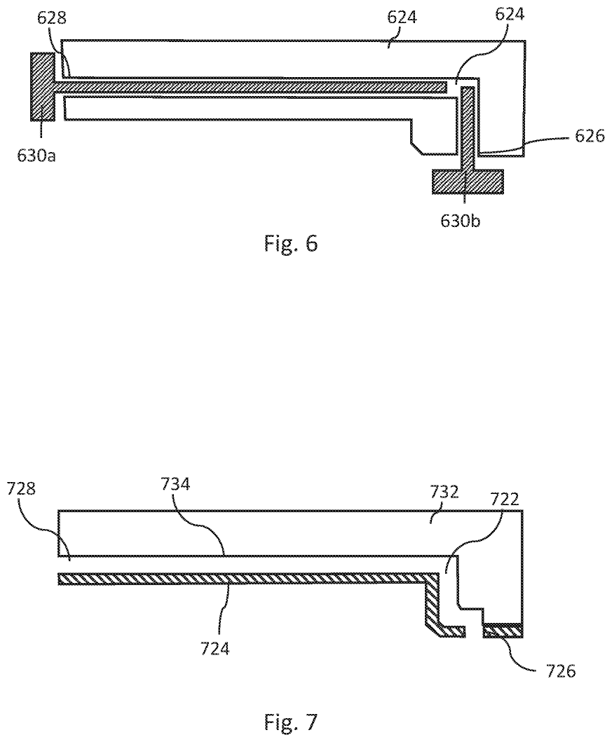

In another example the channel may be integral with the housing of the motor assembly. FIG. 6 shows an example schematic representation of such a housing 624 with a channel 622 extending through the housing 624. In such an example, the housing 624 may be formed by an injection moulding process, with the channel through the housing 624 formed during the injection moulding, e.g. by the use of removable pins 630a, 630b during the injection moulding. In use, in the manner described with reference to FIG. 5, a hole 626 through the housing 624 opens into an impeller inlet of the motor. In use, the second pressure sensor is located at an upstream end 628 of the channel 622. This provides a fluid connection via the channel 622 to the second pressure sensor and allows the second pressure configured to take pressure measurements of the pressure at the impeller inlet. This may allow the second pressure sensor to be conveniently located. The second pressure sensor may, for example, be located on a circuit board of the device. Further, forming the channel 622 integrally with the housing 624 may be cost effective and convenient.

In another example, the channel may be formed between an exterior surface of the housing and a mount located against the exterior surface of the housing. FIG. 7 schematically illustrates such an example. In FIG. 7, a mount 732, e.g. made of rubber, has a groove 734 therein. The mount 732 seals in an air-tight manner against an exterior surface of the housing 724 which has a hole 726 which, in use, leads to the impeller inlet. A channel 722 is created by a gap provided by the groove 734 in the mount 732 between the mount 732 and the exterior surface of the housing 724. In both of the examples of FIG. 6 and FIG. 7, in use, the second pressure sensor is sealed in an air-tight manner to the channel 622, 722 at the upstream end 628, 728 of the channel 622, 722. For example, in the example of FIG. 7, the mount 732 may be a rubber mount which forms a seal around the second pressure sensor.

In each of the above-described example motor assemblies 100, 400 and variations thereon described with reference to FIGS. 6 and 7, the first pressure sensor 118, 418 is positioned to take pressure measurements at the air inlet 110, 410. The pressure measurements taken by the first pressure sensor 118, 418 include an ambient pressure pa which is measured prior to start-up of the motor. Further, the pressure measurements taken by first pressure sensor 118, 418 include measurements of a first pressure p₁ taken during running of the motor. The temperature sensor 116, 416 is configured to measure an ambient temperature Tₐ. The second pressure sensor 120, 420 is configured to take pressure measurements of a second pressure p₂ at the impeller inlet 130, 430 during running of the motor. Each of the ambient pressure pa, the first pressure p₁ and the second pressure p₂ are absolute pressures.

In an example, measurements taken by the first pressure sensor 118, 418 the second pressure sensor 120, 420 and the temperature sensor 116, 416 are used to determine a dynamic pressure value. This dynamic pressure value may be used to determine an airflow rate through the motor assembly 100, 400. In one example, the dynamic pressure measurement is determined as follows.

A gauge static pressure p_{static} in the motor is determined by subtracting the ambient pressure pa from the first pressure p₁. The first pressure p₁ is typically lower than the ambient pressure pa because the running of the motor causes a partial vacuum to be generated within the motor housing 124, 424.

A gauge total pressure pₜₒₜₐₗ at the impeller inlet is determined by subtracting the second pressure p₂ from the first pressure p₁. The total pressure pₜₒₜₐₗ at the impeller inlet is made up of the static pressure p_{static} and a dynamic pressure p_{dyn}. The second pressure p₂ is typically lower than the first pressure p₁ due to the lower cross-sectional area and associated higher air velocity at the impeller inlet 130, 430 as compared with at the motor inlet 110, 410.

The dynamic pressure p_{dyn} at the impeller inlet 130, 430 is determined by subtracting the static pressure p_{static} in the motor from the total pressure pₜₒₜₐₗ at the impeller inlet 130, 430. The dynamic pressure p_{dyn} may also be referred to as an air velocity pressure.

The dynamic pressure p_{dyn}, the first pressure p₁ and the temperature Tₐ are input into a density ratio formula to determine the dynamic pressure value at STP p_{dyn@STP}. The value of p_{dyn@STP} is a dynamic pressure value corrected to standard temperature and pressure. Accordingly, the dynamic pressure value is normalised for the ambient conditions in which the motor is operating. This allows, for example, a single look-up curve to be defined relating dynamic pressure values to airflow rates or other parameters. The applicable density ratio for a given motor may depend on a type of the motor. For example, the following density ratio formulae (1) to (3) apply, respectively, for constant power motors, AC series motors, and constant speed motors:

$${p}_{dyn @ STP} = {{p}_{dyn} ( ( \frac{{p}_{1}}{101.325} ) ( \frac{293}{{T}_{a} + 273.15} ) )}^{- ( \frac{2}{3} )} \qquad ( 1 )$$

$${p}_{dyn @ STP} = {{p}_{dyn} ( ( \frac{{p}_{1}}{101.325} ) ( \frac{293}{{T}_{a} + 273.15} ) )}^{- ( \frac{5}{6} )} \qquad ( 2 )$$

$${p}_{dyn @ STP} = {{p}_{dyn} ( ( \frac{{p}_{1}}{101.325} ) ( \frac{293}{{T}_{a} + 273.15} ) )}^{- ( 1 )} \qquad ( 3 )$$

where p_{dyn@STP}, p₁, and p_{dyn} are in units of kPa, Tₐ is in units of degrees Celsius, 101.325 is standard pressure in units of kPa, 293 is standard temperature in units of Kelvin and 273.15 is 0 degrees Celsius in units of Kelvin.

The dynamic pressure value may be mapped to values of airflow rate through the motor. The mapping of dynamic pressure values to airflow rate may be determined, for example, by a calibration process. In such a calibration process, the air-moving device may be operated with an airflow rate measuring apparatus, which may comprise a bell mouth, a venturi, or an orifice plate, being used to measure the airflow rate through the device while at the same time measurements are taken which allow dynamic pressure values to be determined which can be corresponded with airflow measurements. Accordingly, when the device is operated after calibration, dynamic pressure values may be determined and mapped to airflow rate values in order to determine the airflow rate through the device in use.

The above embodiments are to be understood as illustrative examples of the invention. Other embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of determining a value of an airflow rate through a motor assembly of an air-moving device, the method comprising:
measuring, during operation of a motor of the motor assembly, a first value of a first pressure at a first position in the motor assembly;
measuring, during operation of the motor of the motor assembly, a second value of a second pressure at a second position in the motor assembly, the second position being downstream of the first position; and
performing a determination process to determine, based on the first value and the second value, the value of the airflow rate through the motor assembly.

2. The method of claim 1, wherein the determination process comprises determining a first dynamic pressure value of the motor based on the first value and the second value, and wherein the determining of the airflow rate through the motor assembly is based on the first dynamic pressure value.

3. The method of claim 1, wherein the method comprises determining an ambient pressure value and/or an ambient temperature value, and wherein the determining the airflow rate comprises compensating for the determined ambient pressure value and/or the determined ambient temperature value.

4. The method of claim 3, wherein the method comprises measuring the ambient pressure value and/or the ambient temperature value at the first position when the motor is not in operation.

5. The method of claim 1, wherein the first position is located in a first part of the motor assembly having a first cross-sectional area and the second position is located in a second part of the motor assembly having a second cross-sectional area different to the first cross-sectional area.

6. The method of claim 5, wherein the first cross-sectional area is greater than the second cross-sectional area.

7. The method of claim 1, wherein the first position is upstream of a coil assembly of the motor and the second position is downstream of the coil assembly of the motor and upstream of an impeller of the motor.

8. The method of claim 1, wherein the measuring the second value of the second pressure at the second position comprises measuring the second value at a third position fluidly connected to the second position by a first fluid connection, or wherein measuring the first value of the first pressure at the first position comprises measuring the first value at a fourth position fluidly connected to the first position by a second fluid connection.

9. The method of claim 8, wherein the first fluid connection and/or the second fluid connection are provided by one or more respective ducts.

10. The method of claim 9, wherein at least one of the one or more respective ducts is integral with a housing of the motor assembly.

11. The method of claim 8, wherein the first value and the second value are measured by respective first and second pressure sensors located at upstream positions in the motor assembly, and wherein the second pressure sensor is configured to measure the second value at the third position fluidly connected by the first fluid connection to the second position.

12. The method of claim 1, wherein the first value and the second value are measured by respective first and second pressure sensors, wherein the first pressure sensor is at an upstream position in the motor assembly and the second pressure sensor is at a downstream position in the motor assembly.

13. The method of claim 1, wherein the method comprises using the determined airflow rate to determine:
a filter loading condition of the air-moving device;
a blockage condition of the air-moving device; or
a dynamic loading condition of the air-moving device.

14. A set of machine-readable instructions which when executed by a processor of an air-moving device cause the air-moving device to perform the method according to claim 1 any of claim 1 to claim 13.

15. An air-moving device comprising:
a processor; and
a storage comprising a set of machine-readable instructions which when executed by the processor cause the processor to perform the method according to claim 1.

16. The air-moving device of claim 15, comprising:
a first pressure sensor configured to measure the first value of the first pressure at the first position in the motor assembly; and
a second pressure sensor configured to measure the first value of the first pressure at the first position in the motor assembly.

17. The air-moving device of claim 15, wherein the air-moving device is a vacuum cleaner.
